(19) United States
(12) Patent Application Publication
(10) Pub. No.: US 2019/0134825 A1
(43) Pub. Date: May 9, 2019

(54) System for Humanized Control of Quadruped Bionic Robot and Control Method Thereof

(71) Applicant: Shenzhen Zhongji Jinhua Technology Co., Ltd., Shenzhen (CN)

(72) Inventor: Tongyang Zhao, Shenzhen (CN)

(21) Appl. No.: 15/826,739

(22) Filed: Nov. 30, 2017

(30) Foreign Application Priority Data
Nov. 9, 2017 (CN) 201711098717.4

(51) Int. Cl. B25J 13/08; A63H 3/36; A63H 29/22; A63H 30/02

(52) U.S. Cl. CPC B25J 13/085; A63H 30/02; A63H 29/22; A63H 3/36

(57) ABSTRACT

The present disclosure relates to a system for humanized control of a quadruped bionic robot and a control method thereof, wherein an operator's intent of control is realized via a control cord, the magnitude, direction and time sequence of a force applied by the operator act upon a control sensor, a control processing unit processes a sensed signal and outputs a corresponding control signal to a corresponding drive motor to control the quadruped bionic robot. The control method is simple as the interaction between the robot and the operator is more direct.

### CROSS-REFERENCE TO RELATED APPLICATION

This application claims priority to Chinese Application No. 201711098717.4 filed on Nov. 9, 2017, the entire contents of which are hereby incorporated by reference.

### TECHNICAL FIELD

The present invention relates to the technical filed of controlling a quadruped robot, and in particular to a system for humanized control of a quadruped bionic robot and the control method thereof.

### BACKGROUND

A quadruped bionic robot is a robot simulating the structure of a quadruped, with a volume and weight approximate to a real quadruped. It finds an increasingly wider application and can be used in a number of fields such as military, life service, rescues and remedies, recreations, etc., bringing great convenience for people's life and human development.

At present, control for a quadruped bionic robot is mainly carried out in the modes of remote control and autonomous control. As for the mode of remote control, there is a need to provide an additional dedicated remote controller and the control is difficult and easily subject to manipulation errors, requiring a substantial amount of time for learning operations, and it has the defect of untimely and non-intuitive manipulation. As for the mode of autonomous control, a corresponding control program is set so as to allow the robot itself to make decisions like on walking, stopping, speed, turning, etc. Such control mode requires a significant cost for technical development and is not technically mature enough to be generalized as an error in autonomous decision could pose a great risk.

### SUMMARY

To address the aforesaid problems, the invention provides a system for humanized control of a quadruped bionic robot and the control method thereof, which simulate habits of interaction between human and pets. The method is simple and easy to implement, and the system is of simple structure and low cost and easy to generalize.

To achieve the above purpose, one of the solutions employed by the invention is: a system for controlling a quadruped bionic robot, comprising a
robot body, and drive motors for respectively controlling corresponding quadruped movement of the robot body, and further comprising
a control cord for applying a control action to a control sensing unit;
a control sensing unit for sensing a control action of the control cord and sending a sensed signal of the control action of the control cord to a control processing unit; and
a control processing unit for setting control signals corresponding to different sensed signals, receiving and processing the sensed signal from the control sensing unit, and outputting a control signal corresponding to the sensed signal to a corresponding drive motor to control the robot body to perform a corresponding action, wherein
the control cord is connected to the surface of the robot body, the output of the control sensing unit is connected with the input of the control processing unit, and the output of the control processing unit is connected with the drive motors respectively.

To achieve the above purpose, a second solution employed by the invention is a method for controlling a quadruped bionic robot, comprising the following steps:
S1. setting control signals corresponding to different sensed signals with a control processing unit;
S2. performing a control action onto the robot body with a control cord;
S3. a control sensing unit sensing a control action of the control cord and sending a sensed signal of the control action of the control cord to the control processing unit; and
S4. the control processing unit receiving and processing the sensed signal from the control sensing unit, and outputting a control signal corresponding to the sensed signal to a corresponding drive motor to control the robot body to perform a corresponding action.

The invention has the following advantages: the invention is provided with a control sensor for sensing a control action and correspondingly provided with a control processing unit. A control signal corresponding to a sensed signal of a control sensor is set with a control processing unit, an operator's intent of control is realized via a control cord connected to the robot body, the magnitude, direction and time sequence of a force applied by the operator act upon the control sensors and generate a sensed signal to be sent to the control processing unit, the control processing unit interprets the operator's intent of control, processes the sensed signal and outputs a control signal corresponding to the sensed signal to a corresponding drive motor to control the quadruped bionic robot. Thereby, the complex and cumbersome operations in the prior art are replaced by a single control cord to simulate habits of interaction between human and pets, which is simple and easy to implement, and the system is of simple structure and low cost and easy to generalize as the interaction between the robot and the operator is more direct.

### BRIEF DESCRIPTION OF THE DRAWINGS

FIG. 1 is a diagram of a control method of the invention;

FIG. 2 is a block diagram of Embodiment I of the control system; and

FIG. 3 is a block diagram of Embodiment II of the control system.

### DETAILED DESCRIPTION

The present invention is further described below with reference to specific embodiments.

Embodiment I:

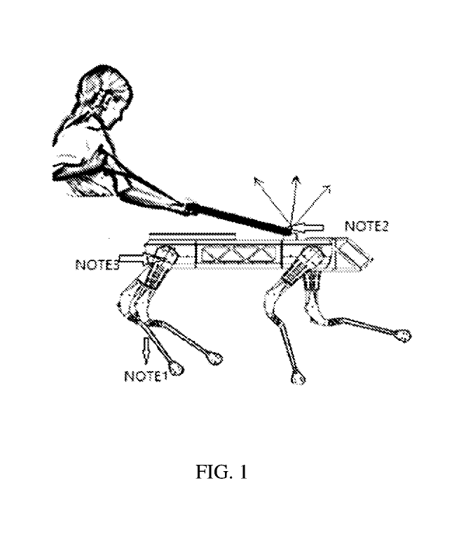

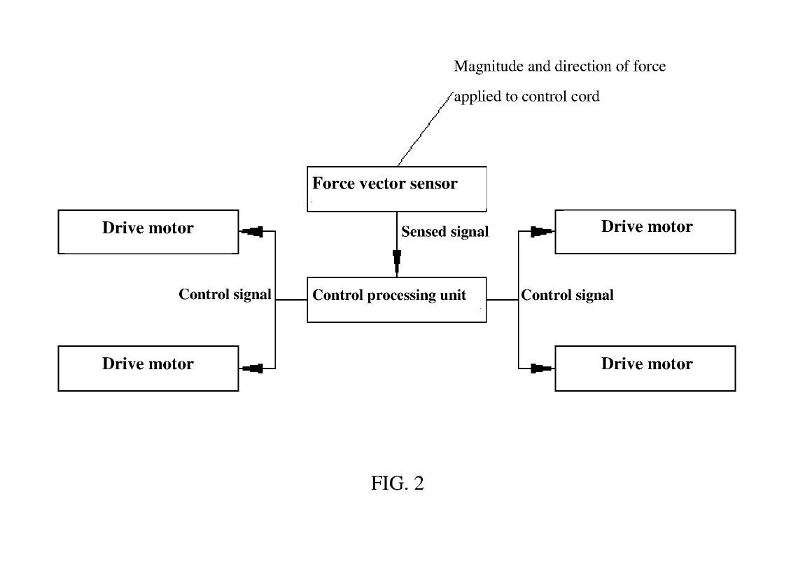

Referring to FIGS. 1 and 2, this embodiment discloses a system for controlling a quadruped bionic robot, comprising a robot body, drive motors for respectively controlling corresponding quadruped movement of the robot body, a control cord, a control sensing unit, and a control processing unit, wherein the control cord is connected to the surface of the robot body, the output of the control sensing unit is connected with the input of the control processing unit, and the output of the control processing unit is connected with the drive motors respectively.

Wherein the control sensing units is a force vector sensor, and a control method is as below:
S1. setting control signals corresponding to different sensed signals in advance with the control processing unit;
S2. performing a control action onto the robot body with the control cord;
S3. sensing a control action of the control cord and sending a sensed signal of the control action of the control cord to the force vector sensor that senses the magnitude and direction of a pull force applied by the operator to the control cord and produces a corresponding sensed signal, e.g. a sensed signal of standing for pulling up, a sensed signal of advancing for pulling forward, a sensed signal of halt for pulling backward, a sensed signal of left or right turning for pulling left or right, a sensed signal of fast action performing for pulling strongly and a sensed signal of gentle and slow action performing for pulling gently, and that sends said sensed signal to the control processing unit; and
S4. the control processing unit receiving and processing the sensed signal, and outputting a control signal corresponding to the sensed signal to a corresponding drive motor to control the robot body to perform a corresponding action, thus realizing the control over the robot body.

As a preferred embodiment, to achieve a more accurate control over the robot body, a control cord can be directly bound on a corresponding force vector sensor to improve the sensing accuracy by directly acting upon the force vector sensor.

Embodiment II:

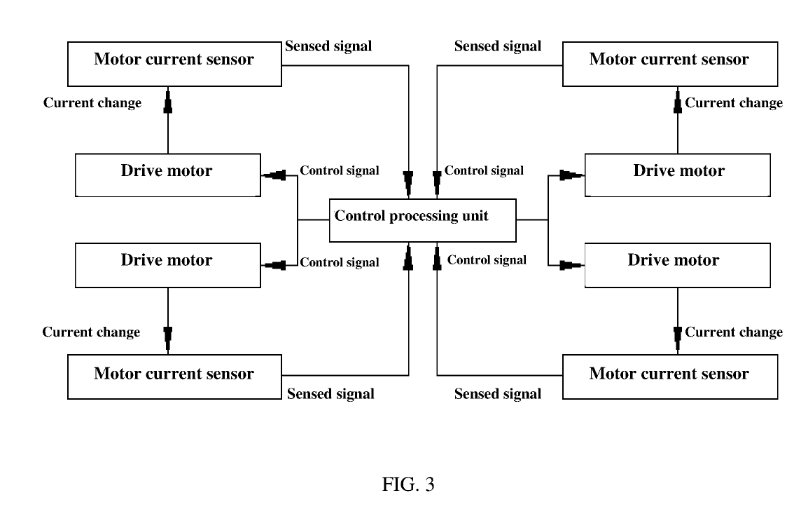

Referring to FIGS. 1 and 3, this embodiment differs from Embodiment I in that, the control sensing unit is a motor current sensor, the motor current sensors are consistent with the drive motors in quantity and are respectively connected with the drive motors; the control cord performs a control action that generates an acting force onto the robot body, the robot body is under force and acts upon a corresponding drive motor to cause current of the drive motor under force to change, and a motor current sensor senses the change of the current of the drive motor and sends a sensed signal to the control processing unit.

As a preferred embodiment, since the current change signal is generated by the control cord acting upon the robot body and then acting upon a specific drive motor via the robot body and is sensed by the motor current sensor, the magnitude and direction of the force applied by the operator to the control cord is indirectly obtained. To achieve a more accurate control over the robot body, the control cord is disposed at a center of the four drive motors so that the magnitude and direction of the force applied by the operator are more uniform and the sensing accuracy is improved.

The above detailed description is merely a description of the preferred embodiments of the invention and by no means limits the scope of the invention. Without departing from the design spirit of the invention, various variations and improvements made by those ordinary skilled in the art shall all fall within the scope defined by the claims of the invention.

1. A system for controlling a quadruped bionic robot, comprising a robot body, and drive motors for respectively controlling corresponding quadruped movement of the robot body, wherein the system further comprises:
a control cord for applying a control action to a control sensing unit;
a control sensing unit for sensing a control action of the control cord and sending a sensed signal of the control action of the control cord to a control processing unit; and
a control processing unit for setting control signals corresponding to different sensed signals, receiving and processing the sensed signal from the control sensing unit, and outputting the control signal corresponding to a sensed signal to a corresponding drive motor to control the robot body to perform a corresponding action;
the control cord being connected to the surface of the robot body, the output of the control sensing unit being connected with the input of the control processing unit, and the output of the control processing unit being connected with the drive motors respectively.

2. The system for controlling a quadruped bionic robot of claim 1, wherein the control sensing unit is a force vector sensor, and the control cord is sleeved on the surface of the force vector sensor; the control cord performs a control action to act upon the force vector sensor, the force vector sensor senses the direction of a force of the control action of the control cord, and sends a sensed signal to the control processing unit, and the control processing unit processes the sensed signal and outputs a control signal corresponding to the sensed signal to a corresponding drive motor.

3. The system for controlling a quadruped bionic robot of claim 1, wherein the control sensing unit is a motor current sensor, the motor current sensors are consistent with the drive motors in quantity and are respectively connected with the drive motors, and the control cord is secured to the surface of the robot body; the control cord performs a control action that generates an acting force onto the robot body, the robot body is under force and acts upon a corresponding drive motor to cause current of the drive motor under force to change, a motor current sensor senses the change of the current of the drive motor and sends a sensed signal to the control processing unit, and the control processing unit processes the sensed signal and outputs a control signal corresponding to the sensed signal to the corresponding drive motor.

4. A control method for applying the system for controlling a quadruped bionic robot of claim 1, comprising the following steps:
S1. setting control signals corresponding to different sensed signals with a control processing unit;
S2. performing a control action onto the robot body with a control cord;
S3. a control sensing unit sensing the control action of the control cord and sending a sensed signal of the control action of the control cord to the control processing unit; and
S4. the control processing unit receiving and processing the sensed signal from the control sensing unit, and outputting a control signal corresponding to the sensed signal to a corresponding drive motor to control the robot body to perform a corresponding action.

5. The control method for a quadruped bionic robot of claim 4, wherein in the step S3, the control sensing unit is a force vector sensor, the control cord performs a control action to act upon a force vector sensor, and the force vector sensor senses the direction of a force of the control action of the control cord and sends a sensed signal to the control processing unit.

6. The control method for a quadruped bionic robot of claim 4, wherein in step S3, the control sensing unit is a motor current sensor, the motor current sensors are consistent with the drive motors in quantity and are respectively connected with the drive motors; the control cord performs a control action that generates an acting force onto the robot body, the robot body is under force and acts upon a corresponding drive motor to cause the current of the drive motor under force to change, and a motor current sensor senses the change of the current of the drive motor and sends a sensed signal to the control processing unit.
